(19) United States
(12) Patent Application Publication
(10) Pub. No.: US 2005/0034281 A1
(43) Pub. Date: Feb. 17, 2005

(54) Belt adjuster

(75) Inventor: Chih-Cheng Shiue, Rancho Santa Fe, CA (US)

Correspondence Address: BRUCE H. TROXELL;SUITE 1404, 5205 LEESBURG PIKE, FALLS CHURCH, VA, 22041, US

(73) Assignee: QDS Injection Molding LLC

(21) Appl. No.: 10/867,750

(22) Filed: Jun. 16, 2004

(30) Foreign Application Priority Data
Aug. 12, 2003 (TW) 92214555

(51) Int. Cl. F16G 11/00

(52) U.S. Cl. 24/132 R

(57) ABSTRACT

A belt adjuster including a base having a bottom with two guides on two opposing sides; an adjustable support located on the base and having a support body with stops; slippers are provided within the support body; a spring is located between said two slippers, and at least one press piece controlling said slippers is provided at opposing sides and above the support body; a top cover is located above the adjustable support; and two belts pass separately through holes in the base, the adjustable support and the top. The slippers selectively are movable between locked and released positions.

### FIELD OF THE INVENTION

The present invention relates to a belt adjuster, more specifically a device used for loosening or fastening the belts of a belt adjuster by pressing a press piece, which is attached to a head-wearing device, such as diving frog goggles.

### BACKGROUND OF THE INVENTION

There are many kinds of common head-wearing devices, such as headbands, helmets, frog goggles, goggles, etc. The primary requirements for these head-wearing devices are that they must be comfortable and be adjustable to meet varying head girths. The degree of comfort could be improved by being able to properly adjust a size of the head-wearing device.

For example, in frog goggles a belt adjuster is absolutely necessary. In the prior art, the belt adjuster is located on both sides of the frog goggles, where the user can adjust the tightness of the belt from at least one side. However, such belts must be respectively adjusted from both sides according to the art. Therefore, it is not convenient, and the belt adjuster on both sides requires some components which impact the design of both sides of the head-wearing device. At the same time, when the belt adjuster is located in both sides, the volume of diving frog goggles is thus enlarged, making them inconvenient.

### SUMMARY OF THE INVENTION

The object of the present invention is to provide a belt adjuster that is adjustable at one location.

The objective of the present invention is to resolve the problems discussed above. The present invention includes a belt adjuster having a base with a bottom with two on both sides; an adjustable support located on the base and having a support body with holes are located on both sides of the support body; two slippers are located between the holes; a spring is located between the two slippers, and at least one press piece controlling the slippers is provided at a side of the support body; a top covers the adjustable support, holes are located on both sides of the top; and two belts pass separately through the holes on the base, the adjustable support and the top.

The main object is that the adjustable support, two corresponding press pieces and the top are provided in order to easily adjust the belt length. By controlling the press pieces of two sides with one hand, the belt can be loosened and tightened as desired, and locked in the predetermined position when the two press pieces are released. The motion for adjusting the tightness of the belt thus is finished when the belt is fastened by the slippers inside of the adjustable support.

A first end of the belt is passes through the belt adjuster of the present invention and a second end is located on the belted article, such as frog goggles. The belt adjuster does not have to be located on a side of the article, which allows for more design variation.

The belt adjuster of the present invention can be positioned on a back of an article and adjusters located on both sides according to the prior art can be eliminated. Also the size of the design can be reduced and the operation for adjusting the belt can be performed by a simple pressing action. The present invention can be applied to, but not limited to, diving frog goggles, goggles, flippers and headlights.

### BRIEF DESCRIPTION OF THE DRAWINGS

FIG. 1 is an exploded view of the belted adjuster for the present invention;

FIG. 2 is a perspective view of the belted adjuster for the present invention;

FIG. 3 is a cross sectional view of the belted adjuster for the present invention;

FIG. 4 is a longitudinal cross sectional view of the belted adjuster for the present invention;

FIG. 5 is a longitudinal sectional view of the belted adjuster for the present invention; and,

FIG. 6 is an exploded view of another embodiment of the belted adjuster of the present invention.

### DETAILED DESCRIPTION OF THE PREFERRED EMBODIMENTS

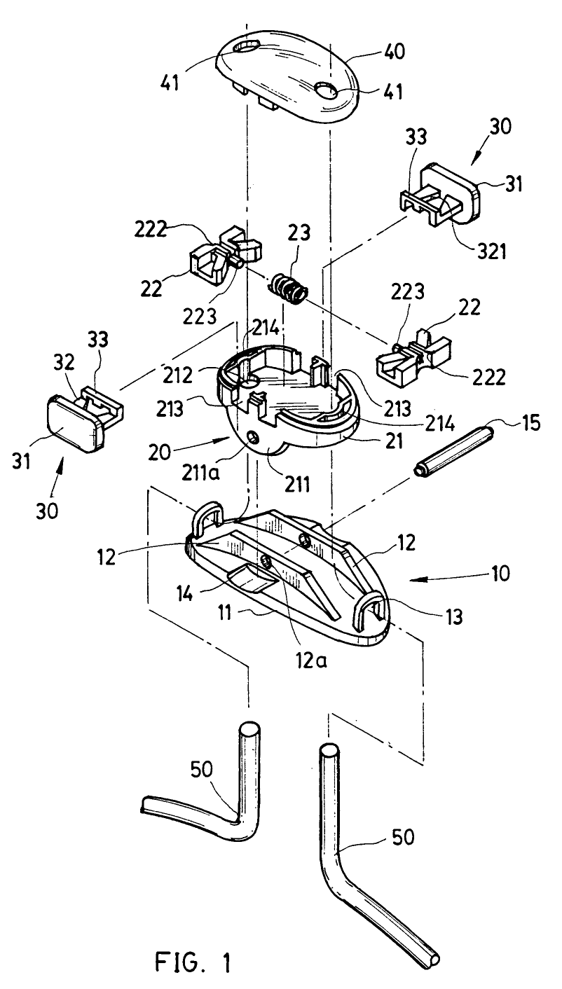

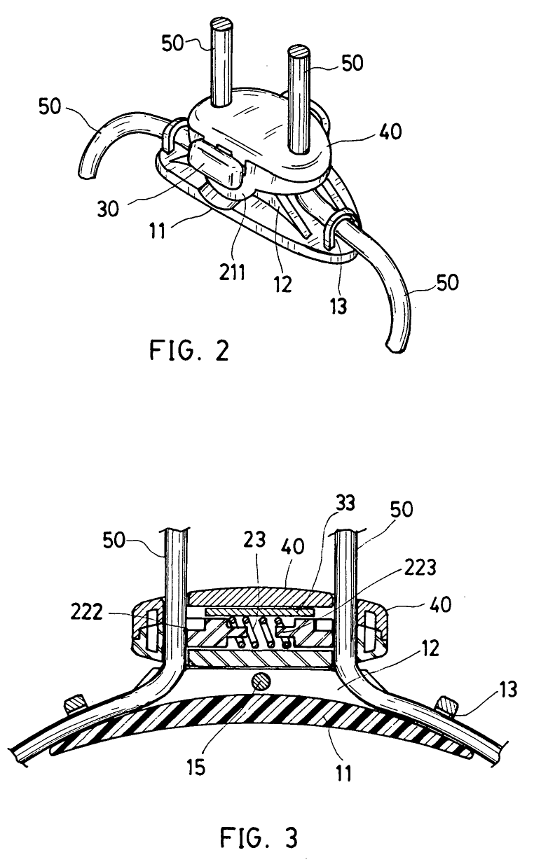

The present invention includes a base 10, an adjustable support 20, two press pieces 30, a top 40 and two belts 50, as shown in FIGS. 1, 2 and 3.

Generally, the belt adjuster is not limited to the use of a head-wearing device, such as frog goggles, but can be widely used with a variety of articles that use a belt. The base 10 can be a plate-like body or it can be contoured. Frog goggles, for example, have a bottom that presses against a user's head, more specifically, contact a back of a head. For some applications a cambered bottom surface, i.e., a surface pressing against the user's head when worn is preferable. Further, the material can be made of soft and tough materials. A structure used for locating the adjustable support is provided on the upper surface.

The base 10 has a bottom 11, two parallel projections 12 that are spaced apart and extend above the bottom 11, two guides 13 located on opposing ends of the bottom 11, two related curved grooves 14 located on opposing sides of the bottom 11 at a middle of the two projections 12, and a base bolt 15 passing through a hole 12a in each of the two projections 12.

The adjustable support 20 includes a support body 21, two slippers 22, a spring 23, and two press pieces 30, all of which are connected with the top 40 and form an integrated structure.

The support body 21 is a box-like structure, which includes two wings 211 extending downwardly, two stops 214, two belt holes 212 and a plurality of guide holes 213. Each of the two wings 211 has a wing hole 211a corresponding to and aligning with the holes 12a of the projections 12. The two wings 211 are located in the curved grooves 14, and the support body 21 is connected to the base 10 by the base bolt 15 which is inserted through holes 12a and wing holes 211a.

The two holes 212 are located on the support body 21 for the belt 50 to pass through. One of the two stops 214 is located above and adjacent to one of the two belt holes 212. The guide holes 213 located in both sides of the support body 21 are used to locate the press pieces 30.

The slippers 22 are located within the support body 21. The belts 50 are passed through the holes 212 and respectively controlled by the slippers 22 pressing the belts 50 against the support body. Each slipper 22 has a slope 221, seizing angles 222 and projections 223; a spring is located on the projections 223 between two slippers 22, and the spring 23 pushes the slippers 22 outwardly to a locked position. The belt 50 is inserted into the seizing angle 222 of each slipper 22. The slippers 22 can be pressed inwardly against the spring 23 to move from the locked position to a released position.

Each press piece 30 includes a platen 31 for pressing, two strips 32 located through the two guide holes 213 on one side of the support body 21. A controlling plate 33 located above the slippers 22 is used for suppressing the slippers 22. Inclined walls 321 of the two strips are located at the interactive position with the slope 221 of the slippers 22.

The top 40 is connected to the adjustable support 20, and two holes 41 exist through the top 40, corresponding with the holes 212, and the belts 50 can be passed through the two holes 41.

Each of the belts 50 is inserted through one of the guide holes 13, passes upwardly through one of the holes 212 of the adjustable support 20, between one of the two stops 214 and the seizing angles 222 of one of the two slippers 22, and through one hole 41 of the top 40. The belt can be pulled when the slippers 20 are moved from the locked position to the released position.

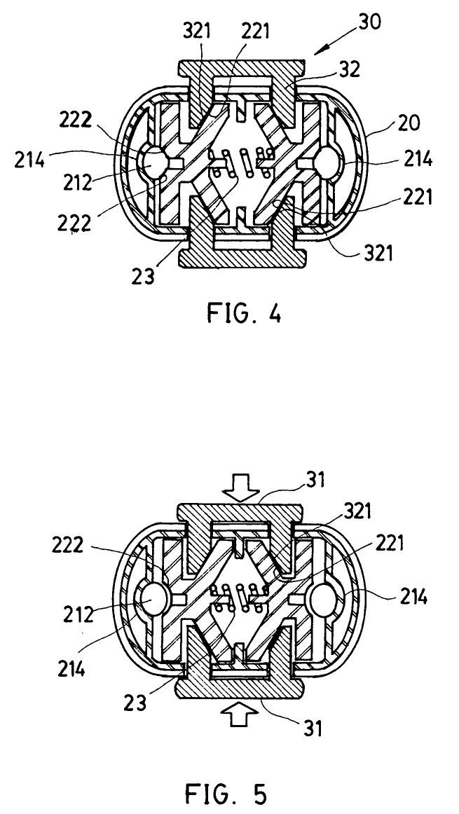

Referring to FIG. 4 and FIG. 5, the press piece 30 can be two parts which are oppositely located on the support body 21 and can be respectively pressed by two fingers at the same time. When pressing the platen 31, the strips 32 move in the guide holes 213, the inclined walls 321 are forced against the slope 221, the controlling plates 33 push against a top of the slipper 22, and the two slippers 22 are forced to move inwardly. At the same time the spring 23 is compressed, and the belt 50 is in a released position and can be adjusted. When the pressure on the platen 31 is released, the spring presses the two slippers outwardly and the belts 50 are positioned between the stops 214 and the seizing angles 222 of the slippers 22.

In use when the belt 50 is fastened to a head, one can press the two press pieces 30 with two fingers in opposite directions, and pull or release the two belts 50 to select a desired tightness with another hand. Once the position is selected, the two press pieces 30 are released and the compressed spring 23 pushes against the slipper 22 via its restoring force, which makes the seizing angle 222 forced on the belt 50, and then the belt 50 is fastened in its tightening state.

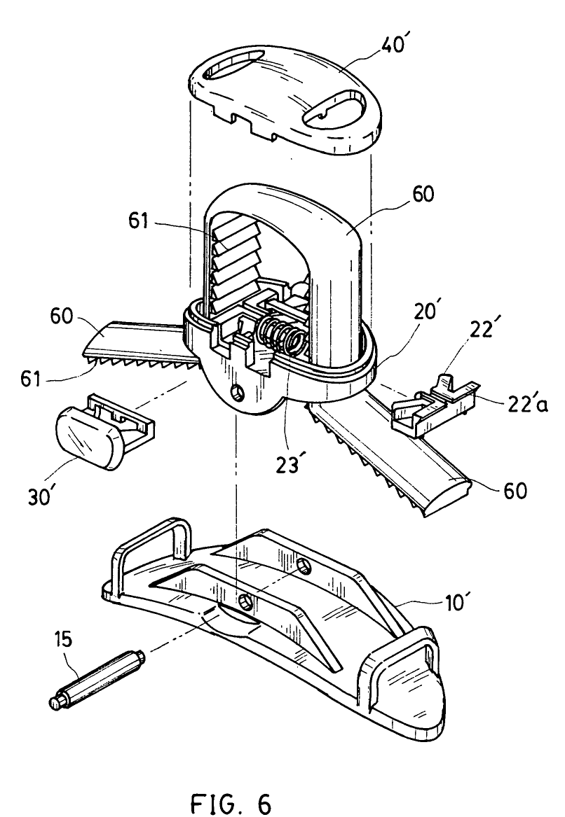

Another embodiment is shown in FIG. 6, wherein the essential function and structure of the following parts, such as a base 10′, an adjustable support 20′, a press piece 30′, and a top 40′ are the same as the above-mentioned belted adjuster. In addition, the slipper 22′ and the spring 23′ have also similar functions and constitution as the slipper 22 and the spring 23.

However, the belt 60 is provided with unilateral ratchet-shaped projections 61, and a flange 22′a is located on the slipper 22′, which engages selected projections 61. When the press piece 30′ is pressed, the flanges 22′a of slipper 22′ exit from engagement with the projections 61, and the belt 60 can be adjusted. When the belt is in a desired location and no force is supplied on the press piece 30′, the projections 61 of belt 60 engage the flanges 22′a thereby locking the belt 60 in place.

The press pieces 30, 30′ shown in above-mentioned embodiments can also be designed as a single structure with similar function, i.e., which is not limited to the said embodiment.

The adjustable support 20 is a structure located on the base 10 and it is not limited to the aforesaid structure. The base 10 could have a shape meeting a variety of heads, but the adjustable support 20 and the base 10 can be formed as a single component.

The disclosed embodiments of the present invention are only the preferred embodiments. Any minor changes or modifications partially or wholly to the present invention conducted by other professional and made publicly known or familiar shall be deemed to be derived from the present inventive concept and will be within the scope of the claims of the present invention.

1. A belt adjuster for a belt comprising:
a) a base;
b) an adjustable support having a support body located on the base;
c) a clamping device located on the adjustable support, the belt being inserted between the clamping device and the adjustable support;
d) at least one press piece selectively moving the clamping device between locked and released positions, wherein, when the clamping device is in the locked position, the clamping device presses against the belt to lock the belt in a preselected position, and when the clamping device is in the released position, the clamping device releases the belt for adjustment; and
e) a top covering the adjustable support.

2. The belt adjuster according to claim 1, wherein the base includes a bottom and two spaced apart and parallel projections extending outwardly from the bottom, the support body includes two wings, each of the two wings is connected to one of the two projections.

3. The belt adjuster according to claim 2, wherein the base includes two grooves, each of the two grooves is located adjacent to one of the two projections, each of the two wings of the support body protrude into one of the two grooves of the base.

4. The belt adjuster according to claim 1, wherein the base includes two guides, the support body includes two belt holes, and the top includes two top holes, a first end of the belt is inserted through a first of the two guides, a first of the two belt holes, and a first of the two top holes, and a second end of the belt is inserted through a second of the two guides, a second of the two belt holes, and a second of the two top holes.

5. The belt adjuster according to claim 4, further comprising two stops, each stop is located on the support body adjacent to one of the two belt holes.

6. The belt adjuster according to claim 1, wherein the clamping device includes two slippers and a resilient member located between and pressing the two slippers apart, each of the two slippers having at least one slope and a seizing angle, the belt is located within the seizing angle and releasably engaged by each of the two slippers, when the clamping device is in the released position, the at least one press piece is pressed against the at least one slope of each of the two slippers to slide the two slippers inwardly against the resilient member such that the belt is adjustable, and when the clamping device is in the locked position, the resilient member slides the two slippers outwardly against the belt such that the belt is locked in the preselected position.

7. The belt adjuster according to claim 6, wherein the at least one press piece includes a platen, two stripes with an inclined wall extending outwardly from the platen, the two stripes are inserted into guide holes in the support body, and each inclined wall of the two stripes engaging the at least one slope of one of the two slippers.

8. The belt adjuster according to claim 7, further comprising a control plate connected to each of the at least one press piece, wherein each of the two slippers is positioned between the control plate and the support body.

9. The belt adjuster according to claim 5, further comprising two stops, each stop is located on the support body adjacent to the seizing angle of one of the slippers with the belt located there between.

10. The belt adjuster according to claim 1, wherein the base and the adjustable support are integrally formed.

11. The belt adjuster according to claim 1, wherein the belt includes a plurality of ratchet-shaped projections extending from at least one surface thereof, the clamping device includes at least one slipper having a flange selectively engaging at least one of the plurality of ratchet-shaped projections of the belt.
